(19) United States
(12) Patent Application Publication
(10) Pub. No.: US 2006/0226309 A1
(43) Pub. Date: Oct. 12, 2006

(54) Display rack assembly

(76) Inventor: Barbara Pao, Taichung (TW)

Correspondence Address: PHILLIP LIU, 6980, WHITEOAK DR., RICHMOND, BC, V7EAZ9, CA

(21) Appl. No.: 11/103,573

(22) Filed: Apr. 12, 2005

(51) Int. Cl. F16M 11/00

(52) U.S. Cl. 248/122.1; 248/176.1

(57) ABSTRACT

A display rack includes a leg portion and a connection member is connected to a top of the leg portion. The connection member includes a first recess and a second recess, and a passage is defined in communication between the first and second recesses. A block is movably received in the passage. An operation member is pivotably engaged with the second recess and includes a push end which pushes a first end of the block into the first recess. A display member has an insertion inserted in the first recess and the insertion is urged by a second end of the block when the block is pushed by the operation member.

### FIELD OF THE INVENTION

The present invention relates to a display rack assembly that is easily to be assembled and operated.

### BACKGROUND OF THE INVENTION

A conventional display rack generally includes hooking members which are fixed to a wall and a support member is connected to the hooking members so as to display merchandise on the support member. The display racks have to be fixed on a wall and cannot be used for outdoor display. As shown in FIG. 5, another conventional display rack includes an H-shaped base and a post is connected to a top of the base. A support member including an inclined surface is connected to an end of the post. Although the display rack is portable, it is a bulky rack and not convenient for being carried and transportation. Furthermore, the H-shaped base is not big enough for providing the rack a stable and reliable base so that the display rack falls easily by any minor impact or even a strong wind blowing the support member on the top of the post.

The present invention intends to provide a display rack that is assembled by several parts which are easily carried and operated.

### SUMMARY OF THE INVENTION

The present invention relates to a display rack that comprises a leg portion and a connection member is connected to a top of the leg portion. The connection member has a first recess and a second recess respectively defined in a top thereof. A passage is defined in communication between the first and second recesses so that a block is movably received in the passage. An operation member is pivotably engaged with the second recess and includes a push end which is located beside a first end of the block. A display member has an insertion inserted in the first recess and is urged by a second end of the block when the block is pushed by the operation member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the display rack of the present invention;

FIG. 2 shows that the display member is to be inserted in the first recess in the connection member;

FIG. 3 shows that the insertion is urged by the block which is pushed by the operation member;

FIG. 4 shows a perspective view of the display rack of the present invention, and

FIG. 5 shows a conventional display rack.

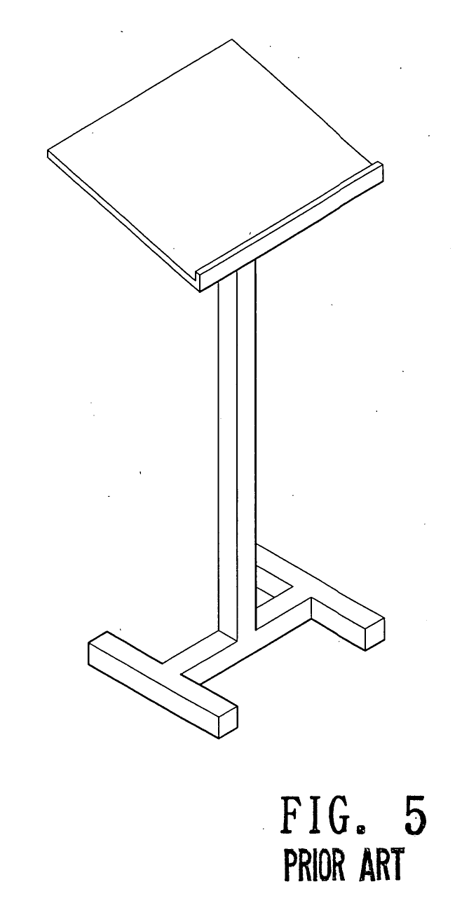

### DETAILED DESCRIPTION OF THE PREFERRED EMBODIMENT

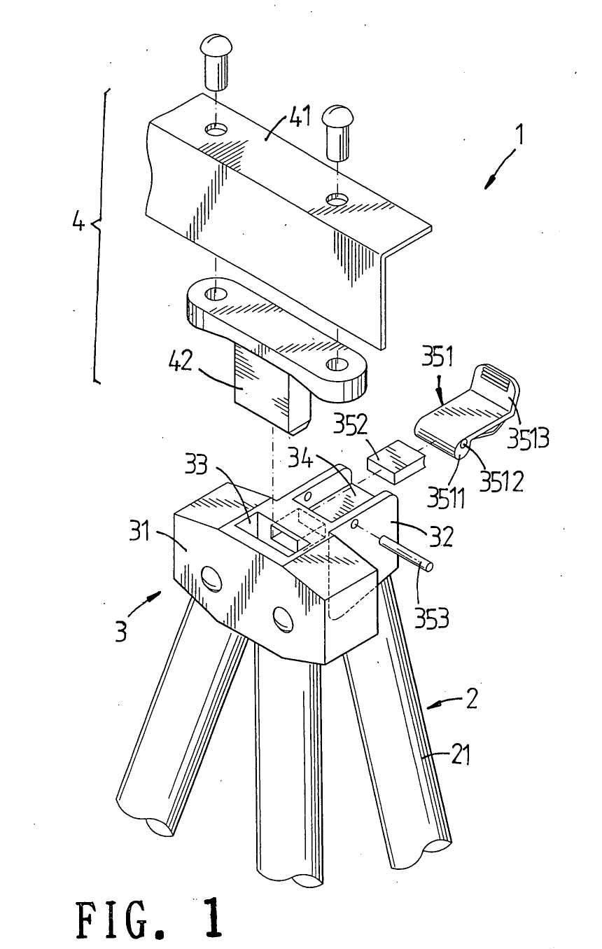

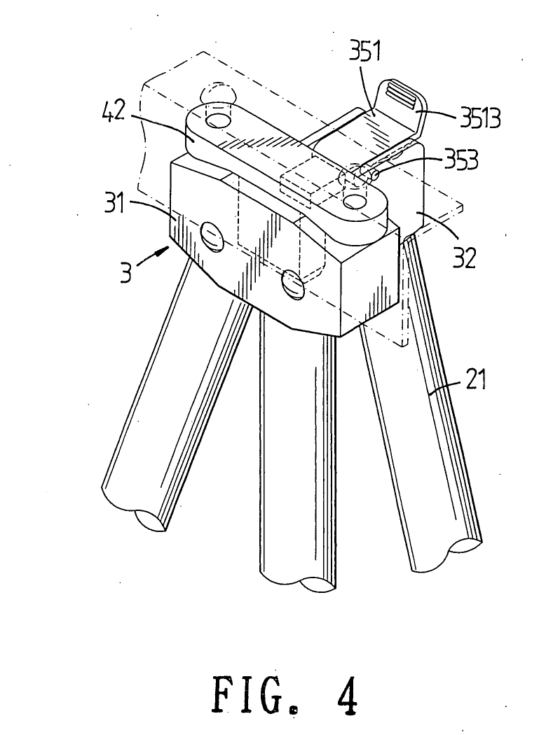

Referring to FIGS. 1, 2 and 4, the display rack 1 of the present invention comprises a leg portion 2 and a connection member 3 which is connected to a top of the leg portion 2. A display member 4 is removably connected to the connection member 3. The leg portion 2 includes three legs 21 so as to provide a stable support to the display member 4. The connection member 3 is a T-shaped member and includes a first portion 31 and a second portion 32 which extends from an end of the first portion 31. A first recess 33 is defined in a top of the first portion 31 and a second recess 34 is defined in a top of the second portion 32. A passage is defined in communication between the first and second recesses 33, 34. A block 352 is movably received in the passage.

An operation member 351 has a push end at a first end thereof and a lever 3513 extends inclinedly from a second end opposite to the push end of the operation member 351. The push end in this embodiment is a cam end 3511 and a through hole 3512 is defined transversely therethrough so that the operation member 351 is pivotably engaged with the second recess 34 by a pin 353 extending through two walls on two sides of the second recess 34 and the through hole 3512.

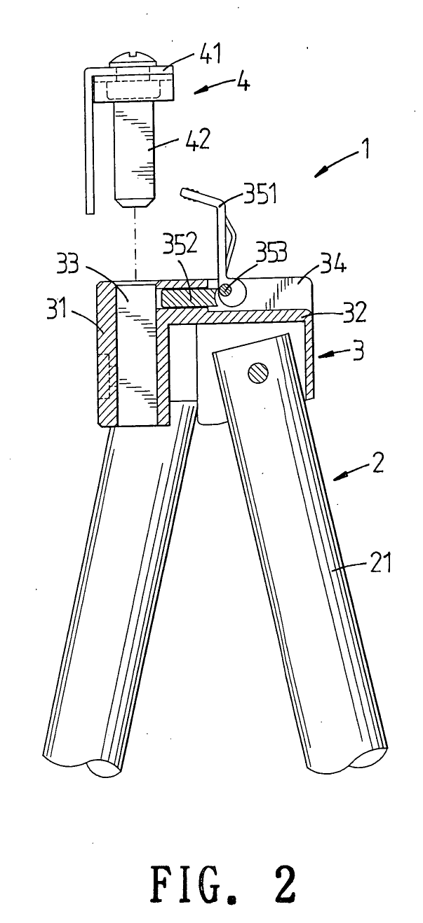

The display member 4 has an insertion 42 and a top plate is connected to a top of the insertion 42, and an L-shaped board 41 is fixed to the top plate. The insertion 42 is inserted in the first recess 33 when the operation member 351 is pivoted upward as shown in FIG. 2, a distance is defined between the first end of the block 352 and the cam end 3511.

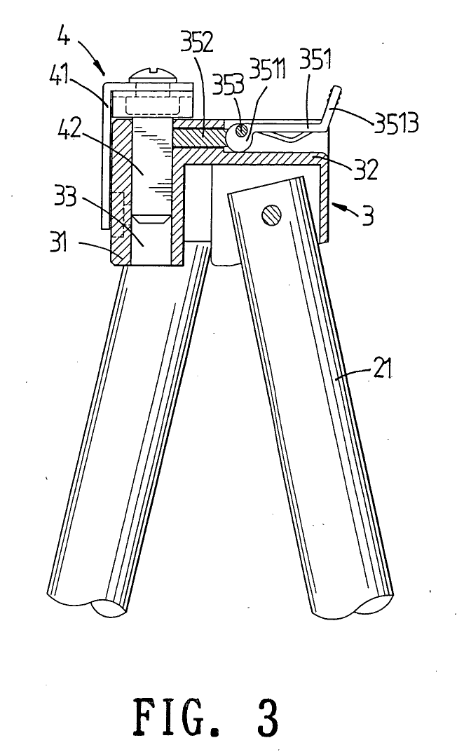

As shown in FIG. 3, when the operation member 351 is pivoted downward as shown, the first end of the block 352 is pushed by the cam end 3511 and the insertion 42 is urged by the second end of the block 352 so that the display member 4 is positioned.

The display rack can be easily disassembled into several parts which are easily to be carried.

While we have shown and described the embodiment in accordance with the present invention, it should be clear to those skilled in the art that further embodiments may be made without departing from the scope of the present invention.

What is claimed is:

1. A display rack comprising:
a leg portion and a connection member connected to a top of the leg portion, the connection member having a first recess and a second recess respectively defined in a top thereof, a passage defined in communication between the first and second recesses, a block movably received in the passage, an operation member pivotably engaged with the second recess and including a push end which is located beside a first end of the block, and
a display member having an insertion inserted in the first recess and is urged by a second end of the block when the block is pushed by the operation member.

2. The rack as claimed in claim 1, wherein the leg portion 2 includes three legs.

3. The rack as claimed in claim 1, wherein the display member includes a top plate connected on the insertion and an L-shaped board is fixed to the top plate.

4. The rack as claimed in claim 1, wherein the connection member includes a first portion and a second portion which extends from an end of the first portion, the first recess is defined in the first portion and the second recess is defined in the second portion.

5. The rack as claimed in claim 1, wherein the push end is a cam end.

6. The rack as claimed in claim 1 further comprising a lever extending inclinedly from an end opposite to the push end of the operation member.
